(19) United States
(12) Patent Application Publication
(10) Pub. No.: US 2008/0023939 A1
(43) Pub. Date: Jan. 31, 2008

(54) Accessory holder for securing to the kingpin of a trailer

(76) Inventor: Robert F. Mater, Elkhart, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/481,090

(22) Filed: Jul. 5, 2006

(51) Int. Cl. B60D 1/60

(52) U.S. Cl. 280/507

(57) ABSTRACT

An apparatus for securing an accessory to a kingpin of a camper or trailer includes a base having a compound opening and an accessory holder.

### TECHNICAL FIELD

The present invention relates generally to the camper and trailer field and, more particularly, to a holder for securing accessories to the kingpin of a camper or trailer when that camper or trailer is not connected to a towing vehicle.

### BACKGROUND OF THE INVENTION

Over the years a number of accessories have been developed for the hitch receiver of a towing vehicle. The present invention relates to an accessory holder for the kingpin of a disconnected trailer that also functions as a security device to prevent unauthorized towing of that trailer.

### SUMMARY OF THE INVENTION

In accordance with the purposes of the present invention as described herein, an apparatus is provided for securing an accessory to the kingpin of a camper or trailer. The apparatus may be broadly defined as comprising a base including a compound opening and an accessory holder. The compound opening includes two sections and may also be called a keyhole opening. The first section of the keyhole opening is larger than the second section of the keyhole opening. More specifically, the keyhole opening has a first section with a diameter of about 3.0 inches and a second section with a diameter of about 2.125 inches.

More specifically describing the invention, the base includes a forked end adjacent the compound opening. The forked end includes a securing aperture and a fastener is received in that securing aperture. In one possible embodiment the fastener is a threaded bolt and a cooperating nut. The fastener may be tightened to prevent the apparatus from twisting relative to the kingpin.

Still further, the body includes a locking aperture and a latch pin is received in the locking aperture. More specifically, the locking aperture is provided in communication with the first section of the keyhole opening. Additionally, the latch pin includes a head end and a lock receiving end. A lock is engaged on the latch pin in an aperture in the lock receiving end thereof. The latch pin and lock function to secure the apparatus on the kingpin. In this position, the apparatus interferes with any effort to connect the trailer to a towing vehicle via the kingpin. Thus, the apparatus also serves a security function so as to prevent unauthorized towing.

In accordance with an additional aspect of the present invention the apparatus may be alternatively described as comprising a base including means for mounting the base to the trailer kingpin and means carried on the base for holding an accessory. Still further, the apparatus may include an accessory.

In accordance with yet an additional aspect of the present invention a method is provided for securing an accessory to a kingpin of a trailer where that kingpin includes a base, a neck and a head. The method comprises securing an accessory holder to the kingpin and securing an accessory to the accessory holder. Still further, the method includes the steps of engaging the neck of the kingpin between the head and the base and fastening the accessory holder in position in engagement with the neck. Still further, the method may include locking the apparatus to the kingpin of a trailer.

In the following description there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING FIGURES

The accompanying drawings incorporated in and forming a part of the specification illustrate several aspects of the present invention, and together with the description serve to explain certain principles of the invention. In the drawings:

FIG. 1 is an exploded perspective view of the apparatus of the present invention;

FIGS. 2a-2b are partially sectional, side elevational views illustrating the first two steps in mounting the apparatus of FIG. 1 to the kingpin of a camper or trailer;

FIGS. 2c-2f are top plan views showing the next four steps in mounting the apparatus to the kingpin; and

FIG. 3 is a perspective view showing the apparatus mounted to the kingpin of a trailer.

Reference will now be made in detail to the present preferred embodiment of the invention, an example of which is illustrated in the accompanying drawings.

### DETAILED DESCRIPTION OF THE INVENTION

Reference is now made to the drawing figures illustrating the apparatus 10 of the present invention for securing an accessory to a kingpin of a camper or trailer T. As illustrated, the apparatus 10 includes a base 12 and an accessory holder 42. The base 12 may be constructed from any appropriate material including, for example, metal such as steel, brass and aluminum, various plastics, including, for example, ABS and nylon or even other materials such as wood. The accessory holder 42 may take the form of one or more sockets or apertures or any other appropriate structure such as a bracket capable of holding a desired accessory.

As illustrated the base 12 includes a compound or keyhole opening generally designated by reference numeral 16. The keyhole opening 16 includes a first, larger section 18 having a width or diameter of about 3.0 inches and a second or smaller section 20 having a width of about 2.125 inches.

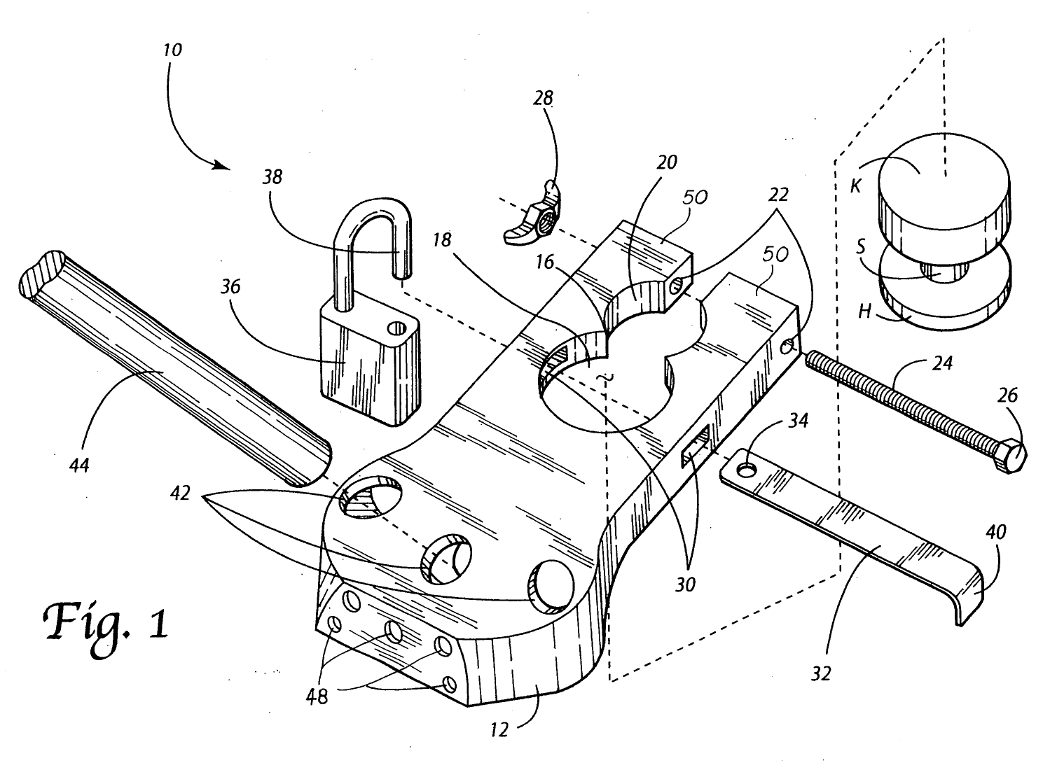

As best illustrated in FIG. 1, the end of the body 12 opposite the accessory holders 42 is forked and the keyhole opening 16 is provided adjacent the forked end with the smaller or second section 20 closest to that end. A securing aperture 22 extends through the sidewalls of the body 12 at the forked end. A fastener, illustrated as a threaded bolt 24 and cooperating wing nut 28, is received in the securing aperture 22. The fastener 24 is tightened to prevent the apparatus 10 from turning or twisting relative to the kingpin K. Thus, for example, flags 46 blowing in the wind won't cause the apparatus 10 to spin on the kingpin K.

As further illustrated in FIG. 1, the apparatus 10 includes a locking aperture 30 that extends through the sidewalls of the base 12 in communication with the first section 18 of the keyhole aperture 16. A latch pin 32 is received in the locking aperture 30 in order to lock the apparatus 12 on the kingpin. As illustrated, the latch pin 32 includes a head end 40 and a lock receiving end 34 illustrated as an aperture. When the latch pin 32 is properly received in the locking aperture 30, the head 40 extends from one side of the base 12 while the aperture 34 extends from the other. The bolt 38 of a padlock 36 may be passed through the aperture 34 and the padlock 36 secured in order to securely fix the apparatus 10 to a kingpin in a manner that will be described in greater detail below.

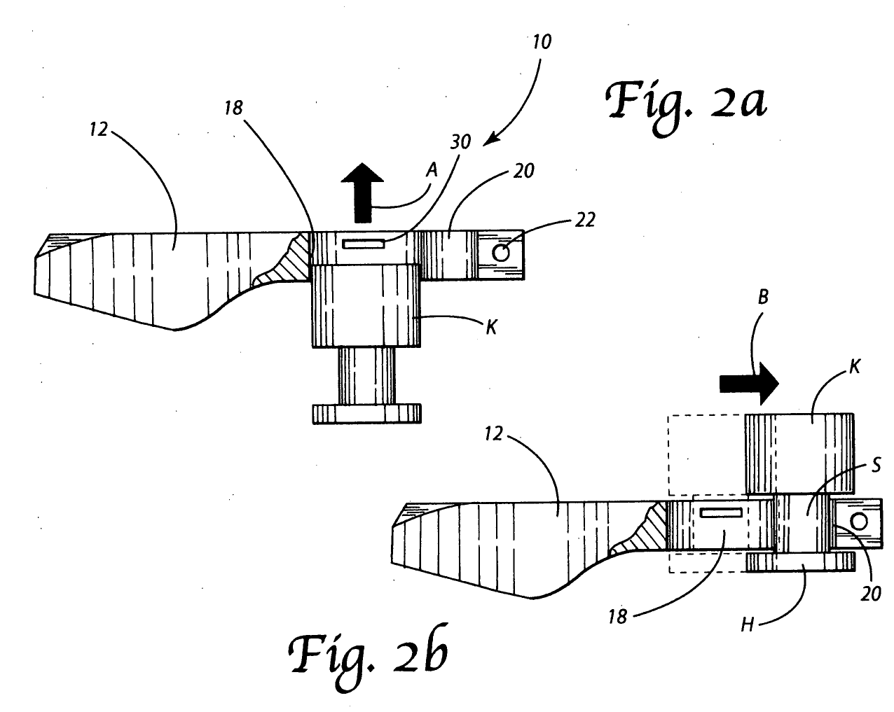

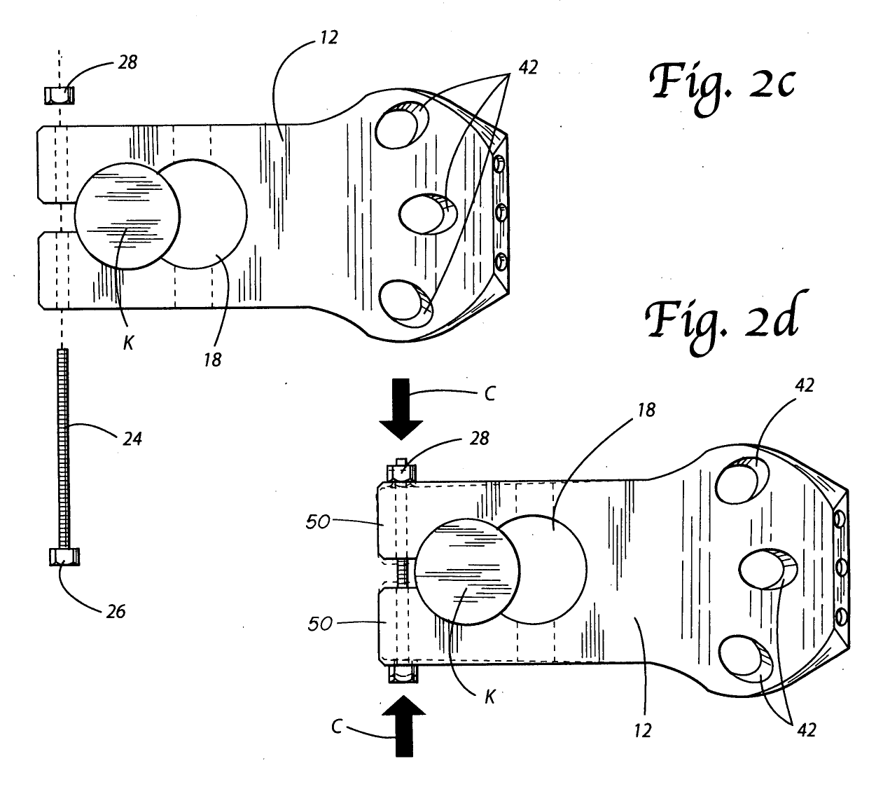

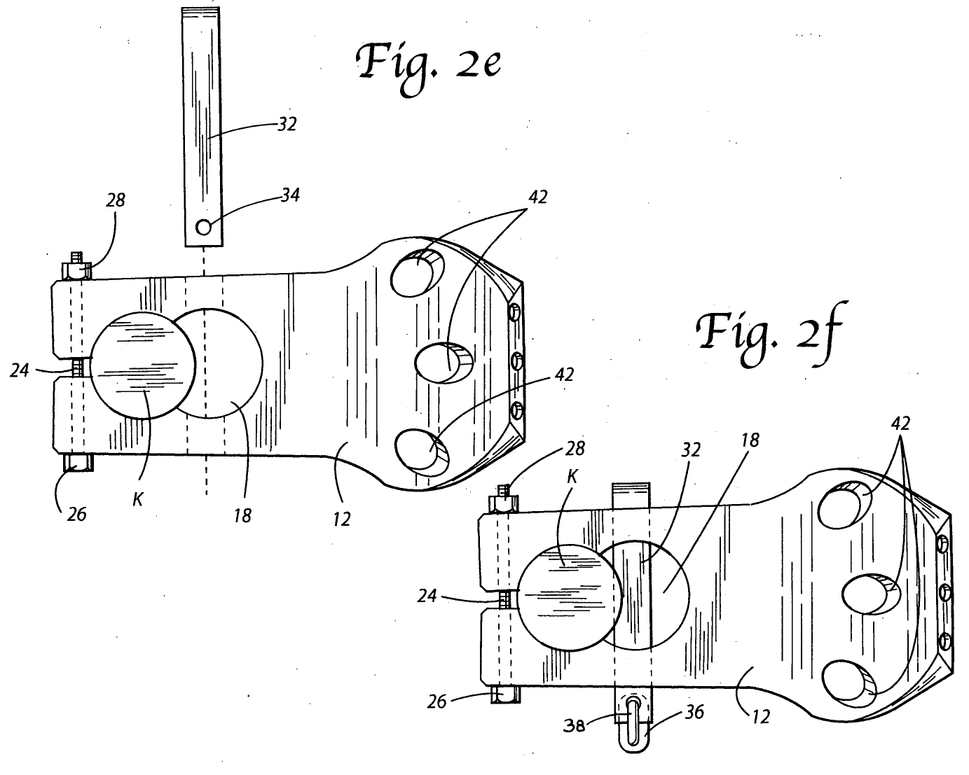

The mounting of the apparatus 10 of the present invention to the kingpin K of a camper or trailer T will now be described with reference to FIGS. 2a-2e. First, the base 12 is positioned over the kingpin K. As illustrated in FIG. 2a, this is accomplished by aligning the first or larger section 18 of the keyhole aperture 16 with the head H of the kingpin K and then passing the head H through the first section of the keyhole aperture as illustrated by action arrow A.

When the base 12 is aligned with the neck S of the kingpin K, the base 12 is shifted laterally in the direction of action arrow B (see FIG. 2b) until the neck S of the kingpin is received in the second section 20 of the keyhole aperture 16. Here it is significant to note that the gap between the forked sections 50 of the base 12 is narrower than the diameter of the neck S of the kingpin K thereby preventing passage of the kingpin through the end of the base. Next, the fastener bolt 24 is positioned in the securing aperture 22 (see FIG. 2c). More specifically, the bolt 24 is fully inserted in the aperture 22 until the head 26 of the bolt engages one sidewall of the base 12. The cooperating wing nut 28 is then tightened on the bolt 24 thereby causing the forked end sections 50 of the base 12 to draw together, tightening the second section 20 of the keyhole aperture 16 around the neck N of the kingpin K (note action arrows C in FIG. 2d). As a result, the sides of the base 12 forming the second aperture section 20 engage the neck N of the kingpin K thereby preventing the apparatus 10 from twisting relative to the kingpin.

It is possible to securely lock the apparatus 10 to the kingpin K in the manner illustrated in FIGS. 2e and 2f. More specifically, the latch pin 32 is inserted through the locking aperture 30 so that the latch pin passes through the first section 18 of the keyhole aperture 16. When fully inserted, the head 40 extends from one side of the base 12 and the aperture 34 extends from the other. The bolt 38 of a padlock is then passed through the aperture 34 and the bolt 38 is then secured in the padlock 36 in order to lock the apparatus 10 in position on the kingpin K. Here it is significant to note that the presence of the apparatus 10 locked in this position on the kingpin K prevents anyone from using the kingpin in order to tow the trailer T. Thus, the apparatus 10 functions to prevent unauthorized towing of the trailer T.

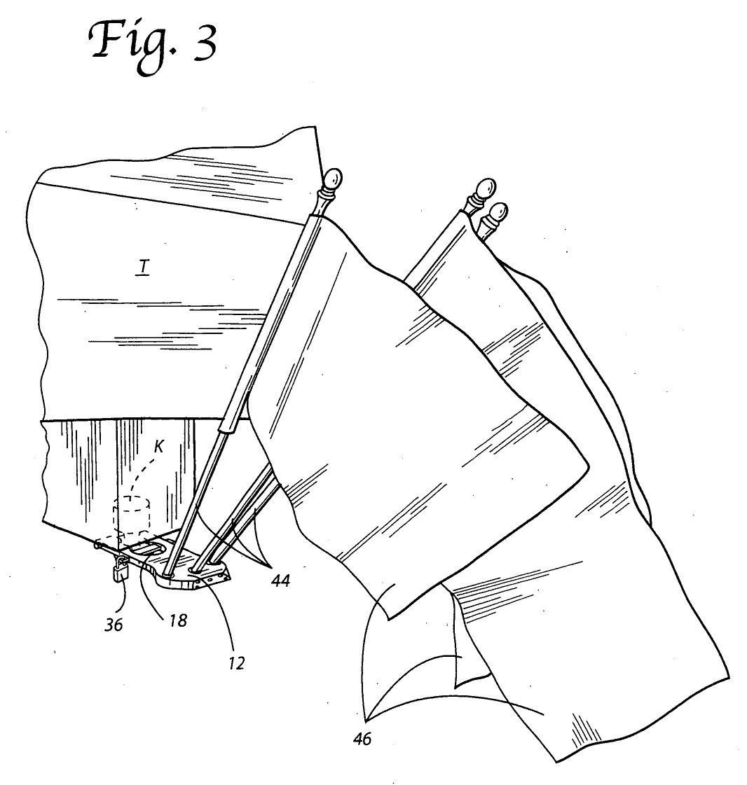

An accessory, such as a flag 46 may then be secured in each accessory holder 42 of the apparatus 10 (see FIG. 3). This is done by simply inserting a flagpole 44 in each opening 42. Additional openings 48 at the front of the base 12 may be used to attach other accessories if desired.

The foregoing description of the preferred embodiment of the invention has been presented for purposes of illustration and description. It is not intended to be exhaustive or to limit the invention to the precise form disclosed. Obvious modifications or variations are possible in light of the above teachings. For example, while a socket or aperture 42 is illustrated as the accessory holder in the drawing figures, it should be appreciated that substantially any other appropriate structure for holding an accessory may be utilized including, for example, a bracket, post, lug, spring clip or the like. Further, while the accessory illustrated in the present invention is a flag 46, it should be appreciated that substantially any other appropriate accessory may be held by the apparatus 10. Such accessories include but are not limited to a bike rack, a utility light, a camp stove, a grill, an exercise machine, a storage receptacle, a radio, a satellite phone, a TV, an antenna, a garbage receptacle or substantially any other device of use in a camping or trailer environment.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiment do not and are not intended to limit the ordinary meaning of the claims and their fair and broad interpretation in any way.

What is claimed:

1. An apparatus for securing an accessory to a kingpin of a camper or trailer, comprising:
a base, including a compound opening and an accessory holder.

2. The apparatus of claim 1 wherein said compound opening includes two sections.

3. The apparatus of claim 1, wherein said compound opening is a keyhole opening.

4. The apparatus of claim 3, wherein said keyhole opening has a first section and a second section and said first section is larger than said second section.

5. The apparatus of claim 3, wherein said keyhole opening has a first section having a diameter of about 3.00 inches and a second section having a diameter of about 2.125 inches.

6. The apparatus of claim 4, wherein said base includes a forked end adjacent said compound opening.

7. The apparatus of claim 6, wherein said forked end includes a securing aperture and a fastener is received in said securing aperture.

8. The apparatus of claim 7, wherein said fastener is a threaded bolt and a cooperating nut.

9. The apparatus of claim 8, wherein said body includes a locking aperture and a latch pin is received in said locking aperture.

10. The apparatus of claim 9, wherein said locking aperture is in communication with said first section of said keyhole opening.

11. The apparatus of claim 10, wherein said latch pin includes a head end and a lock receiving end.

12. The apparatus of claim 11, further including a lock engaged on said latch pin.

13. The apparatus of claim 1, wherein said accessory holder includes a socket for receiving and holding the accessory.

14. The apparatus of claim 13, wherein said accessory is a flag.

15. An apparatus for securing an accessory to a kingpin of a trailer, comprising:
a base including means for mounting said base to the trailer kingpin; and
means carried on said base for holding an accessory.

16. The apparatus of claim 15 further including an accessory.

17. A method of securing an accessory to a kingpin of a trailer where that kingpin includes a base, a neck and a head, comprising:
securing an accessory holder to said kingpin; and
securing an accessory to said accessory holder.

18. The method of claim 17, further including steps of engaging the neck of said kingpin between the head and the base and fastening said accessory holder in position in engagement with the neck.

19. The method of claim 18 including locking the accessory holder to the kingpin.
